(19) United States
(12) Patent Application Publication
(10) Pub. No.: US 2021/0110294 A1
(43) Pub. Date: Apr. 15, 2021

(54) SYSTEMS AND METHODS FOR KEY FEATURE DETECTION IN MACHINE LEARNING MODEL APPLICATIONS USING LOGISTIC MODELS

(71) Applicant: Pearson Education, Inc., Bloomington, MN (US)

(72) Inventors: Zachary S. ELEWITZ, Denver, CO (US); Daniel L. Ensign, Fort Lupton, CO (US)

(21) Appl. No.: 16/598,986

(22) Filed: Oct. 10, 2019

(51) Int. Cl. G06N 20/00; G06N 5/04; G06F 9/451; G06K 9/62

(52) U.S. Cl. CPC G06N 20/00; G06K 9/6223; G06F 9/453; G06N 5/04

(57) ABSTRACT

Systems and methods are disclosed related to the identification of key features among features input to a complex predictive model. Logistic models may be created for each of a number of defined clusters of training data used to train the complex predictive model. Coefficients of each logistic model may be analyzed to identify key features that contribute to predictions made by the logistic models. Performance of the logistic models may be compared to that of the complex model to validate the logistic models. When a prediction is made for a given student by the complex predictive model, the student may be assigned to a cluster/by identifying the cluster center having the shortest Euclidean distance to the feature data associated with the student. Key features associated with the assigned cluster may be used as a basis for generating a recommendation for the reducing a risk level of the student.

### FIELD OF THE INVENTION

This disclosure relates to the field of systems and methods configured to implement logistic models to identify key features in machine learning model applications (e.g., input features having the most impact on machine learning model outputs).

### BACKGROUND

A computer network or data network is a telecommunications network which allows computers to exchange data. In computer networks, networked computing devices exchange data with each other along network links (data connections). The connections between nodes are established using either cable media or wireless media.

Network computer devices that originate, route and terminate the data are called network nodes. Nodes can include hosts such as personal computers, phones, servers as well as networking hardware. Two such devices can be said to be networked together when one device is able to exchange information with the other device, whether or not they have a direct connection to each other.

Computer networks differ in the transmission media used to carry their signals, the communications protocols to organize network traffic, the network's size, topology and organizational intent. In most cases, communications protocols are layered on other more specific or more general communications protocols, except for the physical layer that directly deals with the transmission media.

### SUMMARY OF THE INVENTION

In an example embodiment, a method may include steps of retrieving user data for a plurality of users from an event data store, training a complex predictive model based on a portion of the user data to generate user risk predictions based on inputs that include a set of features, generating, from the portion of the user data, user-specific feature sets including feature values for each feature of the set of features, and identifying a key feature by dividing the user-specific feature sets into a plurality of clusters based on the feature values, generating, for a cluster of the plurality of clusters, a representative logistic model having a plurality of coefficients, each of the plurality of coefficients being associated with a respective feature of the set of features, identifying, for the cluster, the key feature of the set of features based on the plurality of coefficients of the representative logistic model, and storing, in the event data store, the key feature and metadata that associates the key feature with the cluster. The method may further include steps for processing a user-specific feature set of a user with the complex predictive model to generate a risk prediction, in response to generating the risk prediction, determining that the user-specific feature set of the user corresponds to a cluster center of the cluster, determining, based on the metadata, that the key feature is associated with the cluster, generating a guidance recommendation based on the key feature, and causing the guidance recommendation to be displayed at a remote device associated with an instructor of the user.

In some embodiments, the plurality of clusters may be a first plurality of clusters that includes a first quantity of clusters. Identifying the key feature may include generating, for each of the first plurality of clusters, a first plurality of logistic models that includes the representative logistic model, dividing the user-specific feature sets into a second plurality of clusters that includes a second quantity of clusters, generating, for each of the second plurality of clusters, a second plurality of logistic models, dividing the user-specific feature sets into a third plurality of clusters that includes a third quantity of clusters, generating, for each of the third plurality of clusters, a third plurality of logistic models, generating, from a second portion of the user data, second user-specific feature sets, generating first risk predictions with the first plurality of logistic models based on the second user-specific feature sets, generating second risk predictions with the second plurality of logistic models based on the second user-specific feature sets, and generating third risk predictions with the third plurality of logistic models based on the second user-specific feature sets.

In some embodiments, the first quantity may be greater than the second quantity, and the third quantity may be greater than the first quantity.

In some embodiments, the method may further include steps for generating fourth risk predictions with the complex predictive model based on the second user-specific feature sets, and comparing the fourth risk predictions to the first, second, and third risk predictions to determine respective first, second, and third error values.

In some embodiments, the method may further include a step of determining that the first plurality of clusters is associated with minimized error by determining that the first error value is less than the second error value and less than the third error value.

In some embodiments, the first, second, and third error values may include respective first, second, and third root mean square error values.

In some embodiments, the method may further include steps of generating, from a third portion of the user data, third user-specific feature sets, generating fifth risk predictions with the first plurality of logistic models based on the third user-specific feature sets, generating sixth risk predictions with the complex predictive models based on the third user-specific feature sets, determining a fourth error value by comparing the fifth risk predictions to the sixth risk predictions, and validating the first plurality of logistic models by determining that a difference between the first error value and the fourth error value is less than a predetermined threshold.

In an example embodiment, a method may include steps of training, based on a training data set, a complex predictive model to generate risk predictions based on a set of features that characterize student activity, generating, from the training data set, user-specific feature sets, each defining respective feature values for the set of features, dividing the user-specific feature sets into a plurality of clusters, generating a representative logistic model for a cluster of the plurality of clusters, the representative logistic model having a plurality of coefficients, each of the plurality of coefficients being associated with a respective feature of the set of features, identifying, for the cluster, a key feature of the set of features based on the plurality of coefficients, processing a user-specific feature set corresponding to a student with the complex predictive model to generate a risk prediction, determining that the user-specific feature set corresponds to a cluster center of the cluster, determining that the key feature is associated with the cluster, generating a guidance recommendation based on the key feature, and causing the guidance recommendation to be displayed at a remote device.

In some embodiments, the plurality of clusters may include a first quantity of clusters. In some embodiments, identifying the key feature may include steps of generating a first plurality of logistic models that includes the representative logistic model, each of the first plurality of logistic models being generated based on a respectively different cluster of the first quantity of clusters, dividing the user-specific feature sets into a second quantity of clusters, generating a second plurality of logistic models, each of the second plurality of logistic models being generated based on a respectively different cluster of the second quantity of clusters, dividing the user-specific feature sets into a third quantity of clusters, generating a third plurality of logistic models, each of the third plurality of logistic models being generated based on a respectively different cluster of the third quantity of clusters, generating, from a validation data set, second user-specific feature sets, generating first risk predictions with the first plurality of logistic models based on the second user-specific feature sets, generating second risk predictions with the second plurality of logistic models based on the second user-specific feature sets, and generating third risk predictions with the third plurality of logistic models based on the second user-specific feature sets.

In some embodiments, the first quantity may be greater than the second quantity, and the third quantity may be greater than the first quantity.

In some embodiments, the method may further include steps of generating fourth risk predictions with the complex predictive model based on the second user-specific feature sets, and comparing the fourth risk predictions to the first, second, and third risk predictions to determine respective first, second, and third error values.

In some embodiments, the method may include a step of determining that the first quantity of clusters is associated with minimized error by determining that the first error value is less than the second error value and less than the third error value.

In some embodiments, the first, second, and third error values may include respective first, second, and third root mean square error values.

In some embodiments, the method may further include steps of generating, from a testing data set, third user-specific feature sets, generating fifth risk predictions with the first plurality of logistic models based on the third user-specific feature sets, generating sixth risk predictions with the complex predictive models based on the third user-specific feature sets, determining a fourth error value by comparing the fifth risk predictions to the sixth risk predictions, and validating the first plurality of logistic models by determining that a difference between the first error value and the fourth error value is less than a predetermined threshold.

In an example embodiment, a system may include an event data store that stores user data for multiple users and a server. The server may include a processor and a memory configured to store computer-readable instructions. When executed the computer-readable instructions may cause the processor to implement a feature engine, implement a training engine, implement a prediction engine, and cause a guidance recommendation to be displayed at a remote device. The feature engine may be configured to retrieve a portion of the user data form the event data store and generate, from a portion of the user data, user-specific feature sets including feature values for a set of features. The training engine may be configured to train a complex predictive model based on the user-specific feature sets, the complex predictive model being trained to generate risk predictions based on the set of features, divide the user-specific feature sets into a plurality of clusters, and identify a key feature. The key feature may be identified by dividing the user-specific feature sets into a plurality of clusters, generating, for a given cluster of the plurality of clusters, a representative logistic model having a plurality of coefficients, each of the plurality of coefficients being associated with a respective feature of the set of features, identifying, for the given cluster, the key feature of the set of features based on the plurality of coefficients of the representative logistic model, and storing, in the event data store, the key feature and metadata that associates the key feature with the given cluster. The prediction may include the complex model, and may be configured to process a user-specific feature set corresponding to a user with the complex predictive model to generate a risk prediction, and determine that the user is at risk based on the risk prediction. The guidance recommendation may be displayed in response to determining that the user is at risk with the prediction engine.

In some embodiments, to cause the guidance recommendation to be displayed at the remote device, the computer-readable instructions, when executed, may cause the processor to, in response to determining that the user is at risk with the prediction engine, determine that the user-specific feature set corresponding to the user corresponds to a cluster center of the given cluster, determine, based on the metadata, that the key feature is associated with the given cluster, generate a guidance recommendation based on the key feature, and send the guidance recommendation to be displayed at the remote device via an electronic communication network, wherein the remote device is associated with an instructor of the user.

In some embodiments, the computer-readable instructions, when executed, may cause the processor to, generate first, second, and third quantities of clusters, the plurality of clusters corresponding to the first quantity of clusters, generate, first, second, and third pluralities of logistic models to represent, respectively, the first, second, and third quantities of clusters, generate, from a second portion of the user data, second user-specific feature sets, generate, with the first, second, and third pluralities of logistic models, first, second, and third sets of predictions based on the second user-specific feature sets, and determine that the first quantity of clusters and the first plurality of logistic models correspond to minimized prediction error.

In some embodiments, to determine that the first quantity of clusters and the first plurality of logistic models correspond to minimized prediction error, the computer-readable instructions, when executed, may cause the processor to generate, with the complex predictive model, a fourth set of predictions based on the second user-specific data sets, determine first, second, and third error values between respective first, second, and third sets of predictions generated by the first, second, and third pluralities of logistic models and a fourth set of predictions generated by the complex predictive model, and determine that the first error value is less than the second error value and the third error value, wherein the first quantity is less than the second quantity and greater than the third quantity.

In some embodiments, the computer-readable instructions, when executed, may cause the processor to generate, based on a third portion of the user data, third user-specific feature sets, and, upon determining that the first quantity of clusters and the first plurality of logistic models correspond to minimized prediction error, generate a fifth set of predictions with the first plurality of logistic models, generate a sixth set of predictions with the complex predictive model, compare the fifth set of predictions to the sixth set of predictions to determine a fourth error value, and validate the first plurality of logistic models by determining that a difference between the first error value and the fourth error value is less than a predetermined threshold.

In some embodiments, the first, second, third, and fourth error values may be root mean square error values.

The above features and advantages of the present invention will be better understood from the following detailed description taken in conjunction with the accompanying drawings.

### BRIEF DESCRIPTION OF THE DRAWINGS

FIG. 1 illustrates a system level block diagram showing data stores, data centers, servers, and clients of a distributed computing environment, in accordance with an embodiment.

FIG. 2 illustrates a system level block diagram showing physical and logical components of a special-purpose computer device within a distributed computing environment, in accordance with an embodiment.

FIG. 3 illustrates a data store server that may include multiple data stores, in accordance with an embodiment.

FIG. 4A illustrates a system by which features may be derived from data retrieved from one or more data stores, by which one or more risk predictions may be generated for a user by a prediction engine, and by which one or more key features may be identified as corresponding to the user, in accordance with an embodiment.

FIG. 4B illustrates a process by which the prediction engine of the system of FIG. 4A may generate a risk prediction for a user based on features associated with the user and identify one or more key features of those features, in accordance with an embodiment.

FIG. 5A illustrates a process flow for a method of automatic alert triggering, in accordance with an embodiment.

FIG. 5B illustrates a process flow for a method of triggering a pre-emptive alert, in accordance with an embodiment.

FIG. 5C illustrates a process flow for a method of on-the-fly alert triggering customization, in accordance with an embodiment.

FIG. 6 illustrates a process flow for a method of clustering user-specific feature sets, building logistic models on those clusters, and identifying and storing one or more key features for each of the clusters, in accordance with an embodiment.

FIG. 7 illustrates a process flow for a method of generating a guidance recommendation for a user based on one or more key features associated with a cluster corresponding to the user, in accordance with an embodiment.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Network

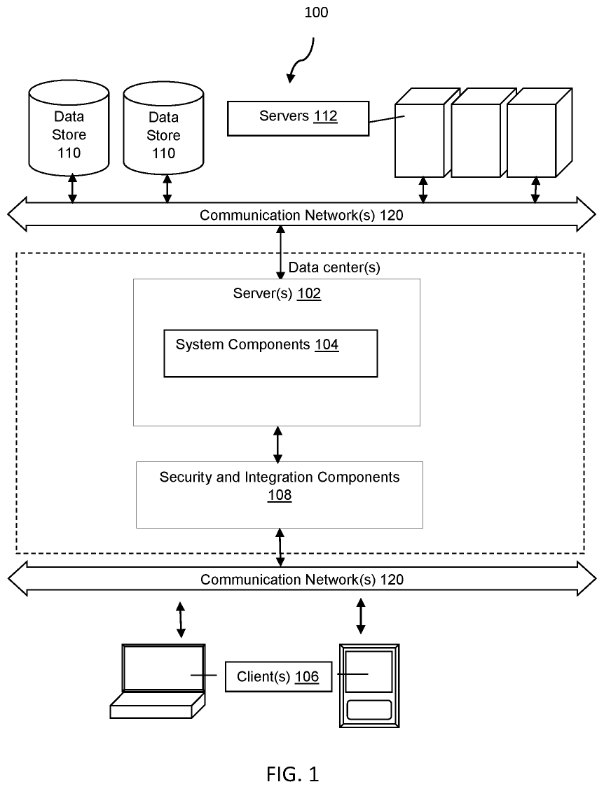

FIG. 1 illustrates a non-limiting example distributed computing environment 100 (sometimes referred to herein as content distribution network 100 or content distribution system 100), which includes one or more computer server computing devices 102, one or more client computing devices 106 (sometimes referred herein to as clients 106 or user devices 106), and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

Servers/Clients

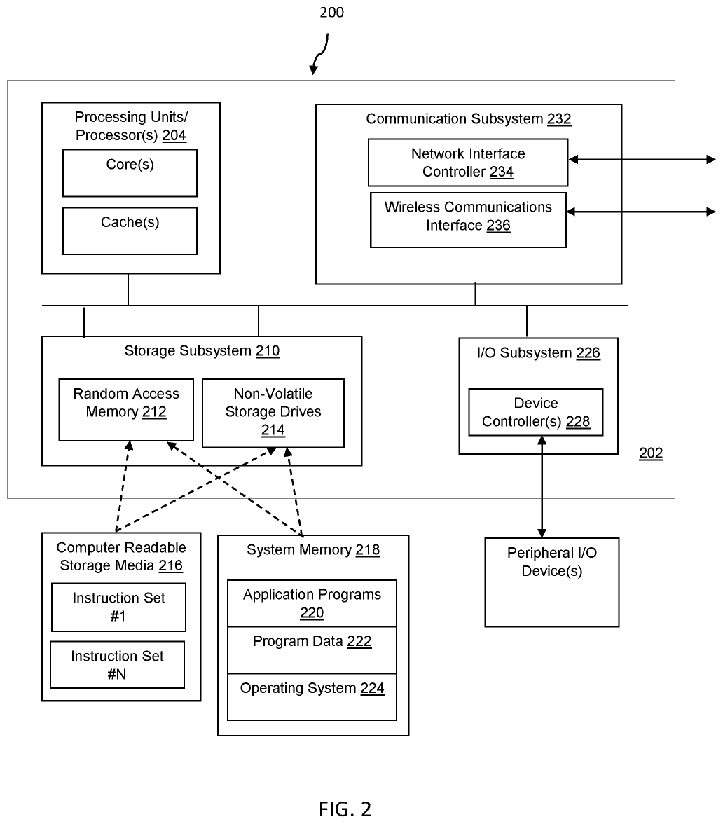

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems and content distribution networks (e.g., content distribution network 100). Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

Security

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Data Stores (Databases)

Content distribution network 100 also may include one or more data stores 110, possibly including and/or residing on one or more back-end servers 112 (sometimes referred to as data store servers 112), operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

Computer System

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

Processors

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Buses

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

Input/Output

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

Input

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

Output

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Memory or Storage Media

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Computer Readable Storage Media

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communication Interface

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

Input Output Streams etc.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

Connect Components to System

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Other Variations

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

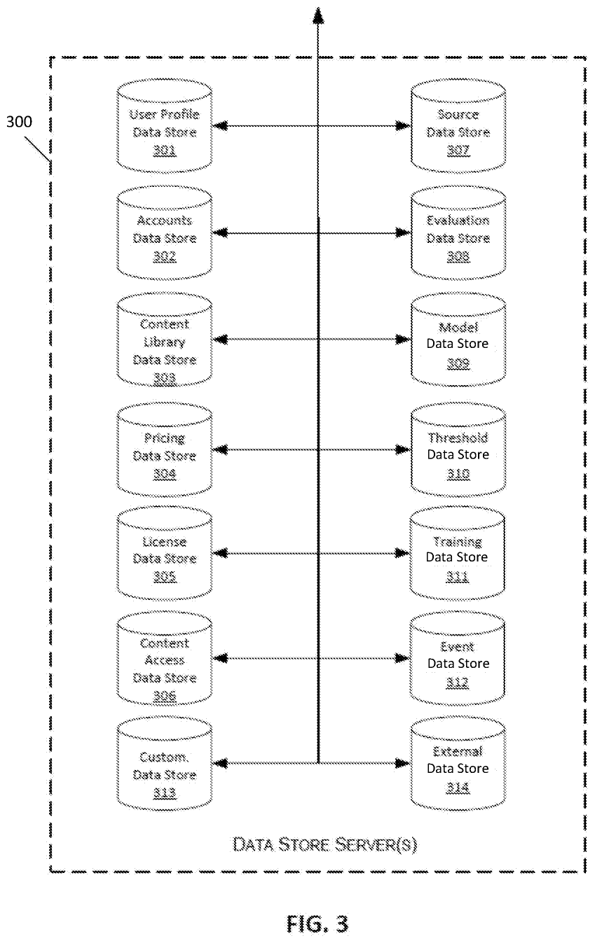

With reference to FIG. 3, an illustrative set of data stores and/or data store servers 300 is shown, (e.g., which may correspond to the data store servers 112 of the content distribution network 100 discussed above in FIG. 1). One or more individual data stores 301-314 (e.g., which may correspond to data stores 110 of FIG. 1) may reside in storage on the one or more data store servers 300 (e.g., which may include a single computer server, a single server farm or cluster of computer servers) under the control of a single entity. In some embodiments, the data stores 301-314 may reside on separate servers 300 operated by different entities and/or at remote locations. In some embodiments, data stores 301-314 may be accessed by a content management server (e.g., content management server 102 of FIG. 1) and/or other devices and servers of a content distribution network (e.g., content distribution network 100 of FIG. 1) that includes the data store server(s) 300. Access to one or more of the data stores 301-314 may be limited or denied based on the processes, user credentials, and/or devices attempting to interact with the data store.

The paragraphs below describe examples of specific data stores that may be implemented within some embodiments of a content distribution network. It should be understood that the below descriptions of data stores 301-314, including their functionality and types of data stored therein, are illustrative and non-limiting. Data store server architecture, design, and the execution of specific data stores 301-314 may depend on the context, size, and functional requirements of a content distribution network. For example, in content distribution systems used for professional training and educational purposes, separate databases or file-based storage systems may be implemented in data store server(s) 300 to store trainee and/or student data, trainer and/or professor data, training module data and content descriptions, training results, evaluation data, and the like. In contrast, in content distribution systems used for media distribution from content providers to subscribers, separate data stores may be implemented in data store server(s) 300 to store listings of available content titles and descriptions, content title usage statistics, subscriber profiles, account data, payment data, network usage statistics, etc.

A user profile data store 301, sometimes referred to herein as a user profile database 301, may include information, also referred to herein as user metadata, relating to the end users within the content distribution network. This information may include user characteristics such as the user names, access credentials (e.g., logins and passwords), user preferences, and information relating to any previous user interactions within the content distribution network (e.g., requested content, posted content, content modules completed, training scores or evaluations, other associated users, etc.). In some embodiments, this information can relate to one or several individual end users such as, for example, one or several students, teachers, administrators, or the like, and in some embodiments, this information can relate to one or several institutional end users such as, for example, one or several schools, groups of schools such as one or several school districts, one or several colleges, one or several universities, one or several training providers, or the like. In some embodiments, this information can identify one or several user memberships in one or several groups such as, for example, a student's membership in a university, school, program, grade, course, class, or the like.

In some embodiments, the user profile data store 301 can include information, such as a risk status, relating to a user's risk level. This risk information can characterize a degree of user risk; a user risk categorization such as, for example, high risk, intermediate risk, and/or low risk; sources of user risk, or the like. In some embodiments, this risk information can be associated with one or several interventions or remedial actions to address the user risk.

The user profile data store 301 can include user metadata relating to a user's status, location, or the like. This information can identify, for example, a device a user is using, the location of that device, or the like. In some embodiments, this information can be generated based on any location detection technology including, for example, a navigation system, or the like. The user profile data store 301 can include user metadata identifying communication information associated with users identified in the user profile data store 301. This information can, for example, identify one or several devices used or controlled by the users, user telephone numbers, user email addresses, communication preferences, or the like.

Information relating to the user's status can identify, for example, logged-in status information that can indicate whether the user is presently logged-in to the content distribution network and/or whether the log-in-is active. In some embodiments, the information relating to the user's status can identify whether the user is currently accessing content and/or participating in an activity from the content distribution network.

In some embodiments, information relating to the user's status can identify, for example, one or several attributes of the user's interaction with the content distribution network, and/or content distributed by the content distribution network. This can include data identifying the user's interactions with the content distribution network, the content consumed by the user through the content distribution network, or the like. In some embodiments, this can include data identifying the type of information accessed through the content distribution network and/or the type of activity performed by the user via the content distribution network, the lapsed time since the last time the user accessed content and/or participated in an activity from the content distribution network, or the like. In some embodiments, this information can relate to a content program comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities, the amount of time since communication with one or several supervisors and/or supervisor devices, or the like.

In some embodiments in which the one or several end users are individuals, and specifically are students, the user profile data store 301 can further include user metadata relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some embodiments, this information can be stored in a tier of memory that is not the fastest memory in the content distribution network.

The user profile data store 301 can include user metadata relating to one or several student learning preferences. In some embodiments, for example, the user, also referred to herein as the student or the student-user may have one or several preferred learning styles, one or several most effective learning styles, and/or the like. In some embodiments, the student's learning style can be any learning style describing how the student best learns or how the student prefers to learn. In one embodiment, these learning styles can include, for example, identification of the student as an auditory learner, as a visual learner, and/or as a tactile learner. In some embodiments, the data identifying one or several student learning styles can include data identifying a learning style based on the student's educational history such as, for example, identifying a student as an auditory learner when the student has received significantly higher grades and/or scores on assignments and/or in courses favorable to auditory learners. In some embodiments, this information can be stored in a tier of memory that is not the fastest memory in the content distribution network.

In some embodiments, the user profile data store 301 can further include user metadata identifying one or several user skill levels. In some embodiments, these one or several user skill levels can identify a skill level determined based on past performance by the user interacting with the content distribution network, and in some embodiments, these one or several user skill levels can identify a predicted skill level determined based on past performance by the user interacting with the content distribution network and one or several predictive models.

The user profile data store 301 can further include user metadata relating to one or several teachers and/or instructors who are responsible for organizing, presenting, and/or managing the presentation of information to the student. In some embodiments, user profile data store 301 can include information identifying courses and/or subjects that have been taught by the teacher, data identifying courses and/or subjects currently taught by the teacher, and/or data identifying courses and/or subjects that will be taught by the teacher. In some embodiments, this can include information relating to one or several teaching styles of one or several teachers. In some embodiments, the user profile data store 301 can further include information indicating past evaluations and/or evaluation reports received by the teacher. In some embodiments, the user profile data store 301 can further include information relating to improvement suggestions received by the teacher, training received by the teacher, continuing education received by the teacher, and/or the like. In some embodiments, this information can be stored in a tier of memory that is not the fastest memory in the content distribution network.

An accounts data store 302 may generate and store account data for different users in various roles within the content distribution network. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303, sometimes referred to herein as a content library database 303, may include information describing the individual content items (or content resources or data packets) available via the content distribution network. In some embodiments, these data packets in the content library data store 303 can be linked to form an object network. In some embodiments, these data packets can be linked in the object network according to one or several sequential relationship which can be, in some embodiments, prerequisite relationships that can, for example, identify the relative hierarchy and/or difficulty of the data objects. In some embodiments, this hierarchy of data objects can be generated by the content distribution network according to user experience with the object network, and in some embodiments, this hierarchy of data objects can be generated based on one or several existing and/or external hierarchies such as, for example, a syllabus, a table of contents, or the like. In some embodiments, for example, the object network can correspond to a syllabus such that content for the syllabus is embodied in the object network.

In some embodiments, the content library data store 303 can comprise a syllabus, a schedule, or the like. In some embodiments, the syllabus or schedule can identify one or several tasks and/or events relevant to the user. In some embodiments, for example, when the user is a member of a group such as a section or a class, these tasks and/or events relevant to the user can identify one or several assignments, quizzes, exams, or the like.

In some embodiments, the content library data store 303 may include metadata, properties, and other characteristics associated with the content resources stored in a content management server (e.g., of the content management server(s) 102 of FIG. 1). Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the content library data store 303 may be configured to allow updating of content metadata or properties, and to allow the addition and/or removal of information relating to the content resources. For example, content relationships may be implemented as graph structures, which may be stored in the content library data store 303 or in an additional store for use by selection algorithms along with the other metadata.

In some embodiments, the content library data store 303 can contain information used in evaluating responses received from users. In some embodiments, for example, a user can receive content from the content distribution network and can, subsequent to receiving that content, provide a response to the received content. In some embodiments, for example, the received content can comprise one or several questions, prompts, or the like, and the response to the received content can comprise an answer to those one or several questions, prompts, or the like. In some embodiments, information, referred to herein as “comparative data,” from the content library data store 303 can be used to determine whether the responses are the correct and/or desired responses.

In some embodiments, the content library data store 303 and/or the user profile data store 301 can comprise an aggregation network, also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some embodiments, the content aggregation can comprise a grouping of content comprising the presentation portion that can be provided to the user in the form of, for example, a flash card and an extraction portion that can comprise the desired response to the presentation portion such as for example, an answer to a flash card. In some embodiments, one or several content aggregations can be generated by the content distribution network and can be related to one or several data packets that can be, for example, organized in object network. In some embodiments, the one or several content aggregations can be each created from content stored in one or several of the data packets.

In some embodiments, the content aggregations located in the content library data store 303 and/or the user profile data store 301 can be associated with a user-creator of those content aggregations. In some embodiments, access to content aggregations can vary based on, for example, whether a user created the content aggregations. In some embodiments, the content library data store 303 and/or the user profile data store 301 can comprise a database of content aggregations associated with a specific user, and in some embodiments, the content library data store 303 and/or the user profile data store 301 can comprise a plurality of databases of content aggregations that are each associated with a specific user. In some embodiments, these databases of content aggregations can include content aggregations created by their specific user and, in some embodiments, these databases of content aggregations can further include content aggregations selected for inclusion by their specific user and/or a supervisor of that specific user. In some embodiments, these content aggregations can be arranged and/or linked in a hierarchical relationship similar to the data packets in the object network and/or linked to the object network in the object network or the tasks or skills associated with the data packets in the object network or the syllabus or schedule.

In some embodiments, the content aggregation network, and the content aggregations forming the content aggregation network can be organized according to the object network and/or the hierarchical relationships embodied in the object network. In some embodiments, the content aggregation network, and/or the content aggregations forming the content aggregation network can be organized according to one or several tasks identified in the syllabus, schedule or the like.

A pricing data store 304 may include pricing information and/or pricing structures for determining payment amounts for providing access to the content distribution network and/or the individual content resources within the network. In some cases, pricing may be determined based on a user's access to the content distribution network, for example, a time-based subscription fee, or pricing based on network usage. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network. For example, the license data store 305 may identify licenses and licensing terms for individual content resources and/or compilations of content resources in the content server, the rights holders for the content resources, and/or common or large-scale right holder information such as contact information for rights holders of content not included in the content server.

A content access data store 306 may include access rights and security information for the content distribution network and specific content resources. For example, the content access data store 306 may include login information (e.g., user identifiers, logins, passwords, etc.) that can be verified during user login attempts to the network. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices, and the like.

An evaluation data store 308 may include information used to direct the evaluation of users and content resources in the content management network. In some embodiments, the evaluation data store 308 may contain, for example, the analysis criteria and the analysis guidelines for evaluating users (e.g., trainees/students, gaming users, media content consumers, etc.) and/or for evaluating the content resources in the network. The evaluation data store 308 also may include information relating to evaluation processing tasks, for example, the identification of users and user devices (e.g., client devices 106 of FIG. 1) included in or coupled to the content distribution network that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

A model data store 309 can store information relating to one or several complex predictive models and one or several simple models. For example, the complex predictive model(s) may include machine-learning algorithms, classifiers, predictive models, and/or the like. The predictive models can be, for example, statistical models. The simple models may include logistic models. In some embodiments, the machine-learning algorithms or processes can include one or several classifiers such as a linear classifier. For example, the machine-learning algorithms can include at least one of: a Random Forest algorithm; an Artificial Neural Network; an AdaBoost algorithm; a Naïve Bayes algorithm; Boosting Tree, and a Support Vector Machine.

In some embodiments these machine-learning algorithms and/or models can include one or several evidence models, risk models, skill models, or the like. In some embodiments, an evidence model can be a mathematically-based statistical model. The evidence model can be based on, for example, Item Response Theory (IRT), Bayesian Network (Bayes net), Performance Factor Analysis (PFA), or the like. The evidence model can, in some embodiments, be customizable to a user and/or to one or several content items. Specifically, one or several inputs relating to the user and/or to one or several content items can be inserted into the evidence model. These inputs can include, for example, one or several measures of user skill level, one or several measures of content item difficulty and/or skill level, or the like. The customized evidence model can then be used to predict the likelihood of the user providing desired or undesired responses to one or several of the content items.

In some embodiments, the risk models can include one or several models that can be used to calculate one or several model function values. In some embodiments, these one or several model function values can be used to calculate a risk probability, which risk probability can characterize the risk of a user such as a student-user failing to achieve a desired outcome such as, for example, failure to correctly respond to one or several assessment item parts, failure to achieve a desired level of completion of a program, for example in a pre-defined time period, failure to achieve a desired learning outcome, or the like. In some embodiments, the risk probability can identify the risk of the student-user failing to complete 60% of the program.

In some embodiments, these models can include a plurality of model functions including, for example, a first model function, a second model function, a third model function, and a fourth model function. In some embodiments, some or all of the model functions can be associated with a portion of the program such as, for example, a completion stage and/or completion status of the program. In one embodiment, for example, the first model function can be associated with a first completion status, the second model function can be associated with a second completion status, the third model function can be associated with a third completion status, and the fourth model function can be associated with a fourth completion status. In some embodiments, these completion statuses can be selected such that some or all of these completion statuses are less than the desired level of completion of the program. Specifically, in some embodiments, these completion statuses can be selected to all be at less than 60% completion of the program, and more specifically, in some embodiments, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some embodiments, a model function can be selected from the plurality of model functions based on a student-user's progress through a program. In some embodiments, the student-user's progress can be compared to one or several status trigger thresholds, each of which status trigger thresholds can be associated with one or more of the model functions. If one of the status triggers is triggered by the student-user's progress, the corresponding one or several model functions can be selected.

The model functions can comprise a variety of types of models and/or functions. In some embodiments, each of the model functions outputs a function value that can be used in calculating a risk probability. This function value can be calculated by performing one or several mathematical operations on one or several values indicative of one or several user attributes and/or user parameters, also referred to herein as program status parameters. In some embodiments, each of the model functions can use the same program status parameters, and in some embodiments, the model functions can use different program status parameters. In some embodiments, the model functions use different program status parameters when at least one of the model functions uses at least one program status parameter that is not used by others of the model functions.

In some embodiments, a skill model can comprise a statistical model identifying a predictive skill level of one or several students. In some embodiments, this model can identify a single skill level of a student and/or a range of possible skill levels of a student. In some embodiments, this statistical model can identify a skill level of a student-user and an error value or error range associated with that skill level. In some embodiments, the error value can be associated with a confidence interval determined based on a confidence level. Thus, in some embodiments, as the number of student interactions with the content distribution network increases, the confidence level can increase and the error value can decrease such that the range identified by the error value about the predicted skill level is smaller.

In some embodiments, the model data store 309 can include a plurality of learning algorithms, classifiers, and/or models and can include information identifying features used by the plurality of learning algorithms, classifiers, and/or models in generating one or several predictions such as, for example, a risk prediction. In some embodiments, for example, some or all of the plurality of learning algorithms, classifiers, and/or models can use different features in generating one or several predictions. These features can be identified in the model data store 309 in association with the plurality of learning algorithms, classifiers, and/or models. In some embodiments, the model data store 309 can further include information identifying a format and/or form for the feature values to be in to allow inputting into the associated one or several of the plurality of learning algorithms, classifiers, and/or models. As used herein, a “feature” may generally refer to a variable representing a category by which a user or the user's activity may be characterized, whereas a “feature value” or “generated feature” may refer to a specific value for that category.

A threshold data store 310, sometimes referred to herein as threshold database 310, can store one or several threshold values. These one or several threshold values can delineate between states or conditions. In one exemplary embodiment, for example, a threshold value can delineate between an acceptable user performance and an unacceptable user performance, between content appropriate for a user and content that is inappropriate for a user, between risk levels, or the like.

A training data store 311, also referred to herein as a training database 311 can include training data used in training one or several of the plurality of learning algorithms, classifiers, and/or models. This can include, for example, one or several sets of training data and/or one or several sets of test data.

A event data store 312, sometimes referred to herein as a fact data store 312 or a feature data store 312 can include information identifying one or several interactions between the user and the content distribution network and any feature values, including values of first-level features or second-level features, generated therefrom.

In some embodiments, the event data store 312 can include instructions and/or computer code that when executed causes the generation of values for one or several features including one or several first-level features and/or one or several second-level features. The event data store 312 can be organized into a plurality of sub-databases. In some embodiments, these can include an interaction sub-database that can include interactions between one or several users and the content distribution network. In some embodiments, this interaction sub-database can include divisions such that each user's interactions with the content distribution network are distinctly stored within the interaction sub-database. The event data store 312 can include a generated feature sub-database, which can include a generated first-level feature sub-database and/or a generated second-level feature sub-database.

The event data store 312 can further include a feature creation sub-database, which can include instructions for the creation/generation of one or several features. For a given user, these one or several features can include, for example, a homework load (e.g., which may be quantified as the user's average homework score over a recent defined period of time, such as the past three weeks); a guessing rate (e.g., quantified via a Hurst coefficient calculated for the student); average correct on first try percent; an average score which can include an average homework score and/or an average test score; an average part score; a number of attempted parts; an average number of attempted parts; an average number of attempts per part; and an aggregation parameter such as, for example, one or several course level aggregations. In some embodiments, these features can be generated from data collected within a window, which window can be a temporally bounded window, or a window bounded by a number of received response. In such an embodiment, for example, the window can be a sliding window, also referred to herein as a sliding temporal window that can include information relating to some or all of one or several users' interaction with the content distribution network during a designated time period such as, for example, a 1 week time period, a ten day time period, a two week time period, a three week time period, a four week time period, a six week time period, a twelve week time period, or any other or intermediate period of time.

In some embodiments, the Hurst coefficient can be a measure of instability in responses received from a user, and specifically a measure of randomness in correct/incorrect responses to one or several questions, and may quantify the guessing rate of the user. The Hurst coefficient can be calculated across a window of data, which window can be limited to a specified time period and/or to a specified number of response.

The average correct on first try percent (CFT %) can be a value indicating the average percent of questions to which the student-user submitted a correct response on a first try. The CFT % can be an indicator of changes to correctness stability. In some embodiments, a given value of this feature can be updated with each additional response received from the student-user. In some embodiments, the average correct on first try percent can be calculated by dividing the number of response that were correct on the first try by the number of questions for which responses were received. In some embodiments, the CFT % can be stored as a percent, or as a normalized value between 0 and 1.

The average score which can include an average homework score and/or an average test score can be the average score received by the user on, for example, homework and/or tests within the window. The average part score can identify the average score received by the user on different problem parts. In some embodiments, for example, a problem can include multiple parts, each of which can be independent evaluated. The average part score can be, for example, the average number of points received for a problem part and/or a percent indicating the average percent of points received per problem part. In some embodiments, the number of attempted parts can be a count of the number of total attempted parts of questions, and the average number of attempted parts can be the average number of attempted parts per question. In some embodiments, the average number of attempts per part can be the average number of attempts for each problem part before the user quits further attempts or correctly responds to the problem part. In some embodiments, the aggregation parameter can include a course level average such as, for example, an average percent correct across all students within a course, and the aggregation parameter can include one or several course level aggregations which can be a delta value indicating the difference between a feature generated for an individual and a similar feature generated for the course.

A customization data store 313 can include information relating to one or several customizations. The customization data store 313 can contain one or several configuration profiles that can identify one or several user attributes and a customization associated with each of those one or several user attributes. In some embodiments, the customization identifies a sub-set of potential features for use in generating a risk prediction, and thus can specify a change to features used in generating a risk prediction. The customization data store 313 can include customizations specific to a single user or to a group of users sharing a common attribute. In some embodiments, the customizations within the customization data store 313 can modify the machine-learning algorithm used in generating a risk prediction. In some embodiments this can include selecting a specific one or several machine-learning algorithms or classifiers that is associated with a unique set of features specified by the customization. In some embodiments, the identification of a customization for use in generating a risk prediction is determined according to a portion of metadata that is non-unique to a user and is unique to a set of users sharing at least one common attribute.

In addition to the illustrative data stores described above, data store server(s) 300 (e.g., data store servers, file-based storage servers, etc.) may include one or more external data aggregators 314. External data aggregators 314 may include third-party data sources accessible to the content management network, but not maintained by the content management network. External data aggregators 314 may include any electronic information source relating to the users, content resources, or applications of the content distribution network. For example, external data aggregators 314 may be third-party data stores containing demographic data, education-related data, consumer sales data, health-related data, and the like. Illustrative external data aggregators 314 may include, for example, social networking web servers, public records data stores, learning management systems, educational institution servers, business servers, consumer sales data stores, medical record data stores, etc. Data retrieved from various external data aggregators 314 may be used to verify and update user account information, suggest user content, and perform user and content evaluations.

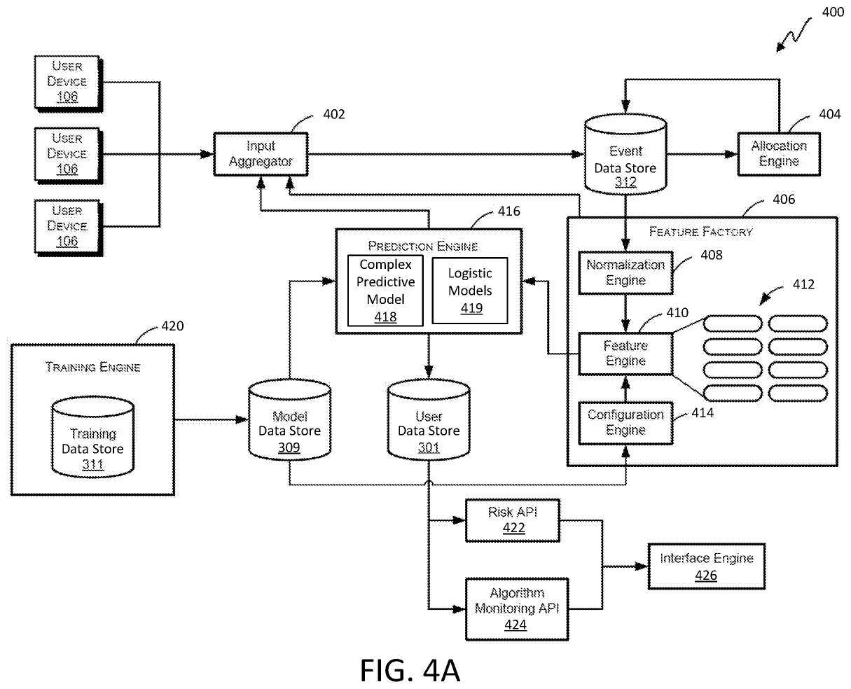

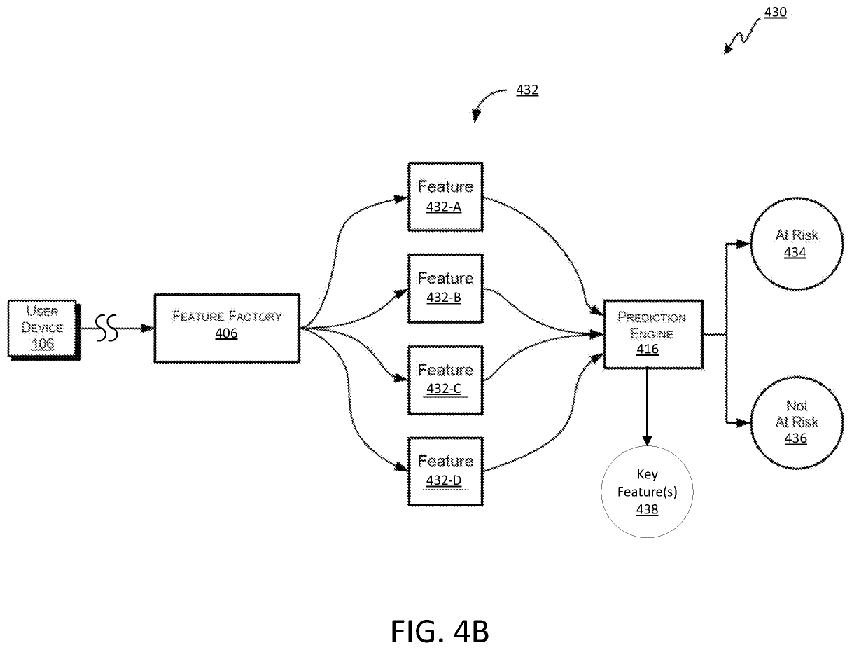

With reference now to FIG. 4A, a schematic illustration of one embodiment of an early alert system 400, also referred to herein as a pre-emptive alert triggering system 400 is shown. The system 400 can include one or several user devices 106 that can be connected to an input aggregator 402. The input aggregator 402 can comprise any hardware, software, or combination thereof that can receive input from multiple devices operating multiple software programs and generate one or several data streams containing those received inputs. In some embodiments, the input aggregator 402 can format and/or transform the received inputs. In some embodiments, the input aggregator 402 can be located on the server 102.

The input aggregator 402 is connected to the event data store 312 such that the outputs of the input aggregator 402 can be stored in the event data store 312 as one or several events. The event data store 312 can be further connected to an allocation engine 404. The allocation engine can reorganize and/or re-allocate data stored in the event data store 312. The re-allocation can be performed on any desired basis including, for example, a date of the activity resulting in the storing of data in the event data store 312, user associated with the data in the event data store 312, discipline associated with the data stored in the event data store 312, or the like. The allocation engine 404 can receive data from the event data store 312, re-allocate and/or reorganize that data, and store the re-allocated and/or reorganized data in the event data store 312.

The event data store 312 can be additionally connected to a feature factory 406 (sometimes referred to as feature engine 406). The feature factory 406 can comprise a hardware, software, or combined hardware/software module that is configured to generate values for one or several features from data identifying events, which data identifying events can be stored in the event data store 312. The feature factory 406 can include a normalization engine that can process data entering the feature factory 406 to improve the efficiency and/or operation of the feature factory 406. This processing can include deduping, transforming, formatting, and/or flattening of data received by the feature factory 406. The feature factory 406 can be located in or on the server 102.

After the data has passed the normalization engine, the data can be received by a feature engine 410 within the feature factory 406. The feature engine 410 can generate one or several features (i.e., feature values) 412 from the data received by the normalization engine. These generated features can be stored in the event data store 312 and/or can be outputted to the input aggregator 402 where they can be entered into the event data store 312 and used for generating any desired higher-level features. The feature engine 410 can generate feature values according to feature generating instructions that can be stored in the data store server 112, and specifically within the event data store 312. In some embodiments, the feature engine 410 can further generate features according to one or several attributes of a configuration profile that can be, for example, stored in a customization data store (e.g., the customization data store 313 of FIG. 3) and that can be provided to the feature engine 410 by the configuration engine 414. In some embodiments, the configuration engine 414 can further receive data inputs from the model data store 309 which can link the configuration profile to one or several models in the model data store 309.

Features 412 generated by the feature factory 406 can be provided to the prediction engine 416. The prediction engine 416 can comprise any hardware, software, or combination thereof that can generate a prediction, and specifically a risk prediction. For example, the risk prediction may be a binary prediction of “at risk” or “not at risk”. For example, with an “at risk” prediction may correspond to one or more indicators of a user's performance (e.g., performance indicators; which may be quantified according to the user's test grades, homework grades, course grades, or some aggregate and/or composite of many grades and grade types) being likely to fall below a predetermined threshold percentage of a population of users. For example, a user may be considered “at risk” if their test scores in a given course are predicted to fall into the bottom 16% of all users participating in that course, or, alternatively, into the bottom 16% of all users represented in the user data stored in user data store 301. A “not at risk” prediction may be indicative of a given user's performance indicator or indicators being predicted to not fall below this predetermined threshold.

The prediction engine 416 can be located in or on the server 102, for example. The prediction engine 416 can include a complex predictive model 418, which may be a machine-learning model such as, for example, a classifier that can generate a risk prediction based on inputs received from the feature factory 406. A definition for the complex predictive model 418 may be stored in and subsequently retrieved from the model data store 309. The complex predictive model can include at least one of: a linear classifier; a Random Forest algorithm; an Artificial Neural Network; an AdaBoost algorithm; a Naïve Bayes algorithm; Boosting Tree, and a Support Vector Machine. The prediction engine 416 can further include logistic models 419. Each logistic model 419 may include one or more variables, with each variable including a corresponding coefficient. Each coefficient-variable pair corresponds to a different feature, with the magnitude of the coefficient identifying how strongly the variable (i.e., feature) influences the prediction made by the logistic model. In some embodiments, each of the logistic models 419 may be built on (e.g., generated based on) a respectively different data cluster. For example, clustering operations such as k-means clustering may be performed on training data (e.g., stored in the training data store 311 of FIG. 3) derived from a larger set of user data (e.g., stored in event data store 312), according to user-specific feature sets that include feature values derived from the user data (e.g., features 412, 432 generated by feature factory 406) to divide the user data into a number of user data clusters, partitioned based on similarity of feature values, with each cluster corresponding to a different logistic model. A user-specific feature set for a given user would be processed using a logistic model of the logistic models 419 that corresponds to the cluster that includes that user's user data. As will be described, the logistic models 419 may be considered “simple model” when compared to the complex predictive model 418, but may approximate (e.g., within a predefined threshold of accuracy) the risk prediction generated by the complex predictive model 418 while also identifying one or more key features of the features 412. Here, the term “key features” refers to those features of the features 412 that contribute more (or the most) to the risk prediction compared to the other features of the features 412. In other words, the “key features” refers to those features of the features 412 that are most heavily weighted in generating the risk prediction. In addition to its relative weighting, the logistic models 419 may identify whether a given feature contributes positively or negatively to the risk prediction (e.g., identifying whether the feature has a positive correlation to the risk prediction, such that risk increases as the feature value increases, or has a negative correlation to the risk prediction, such that risk decreases as the feature value increases and vice versa). For example, user data may be clustered according to the features/variables that are used by the complex predictive model 418 to determine or predict risk (e.g., CFT %, homework load, guessing rate, average test scores, independent homework submission speed following assignment, comparative homework submission speed with respect to that of other students in a class, independent time spent completing homework assignments, comparative time spent completing homework assignments with respect to that of other students in a class, etc.) such that users with similar feature profiles (i.e., feature vectors; user-specific feature sets; the group of feature values corresponding to a given user) are generally assigned to the same cluster.

In some embodiments, the models in the model data store 309 can be based and/or trained by a training engine 420 according to data (e.g., which may be partitioned into training, testing, and validation data sets) stored in the training data store 411. The training engine 420 can comprise any hardware, software, or combination thereof that can train a predictive model. The training engine 420 can be located in or on the server 102.

A given prediction generated by the prediction engine 416 can be output to the input aggregator 402 and stored in the event data store 412 and/or can be output to the user data store 401 and stored in connection with the user for whom the risk prediction was generated. The risk prediction can then be provided to the risk API 422 which can generate one or several graphical depictions based on the risk prediction generated by the prediction engine 416 and/or aggregate the risk prediction generated by the prediction engine 416 with risk predictions for other students/users (e.g., in the same class) and generate one or several graphical depictions of the risk for all of these users or one or more subsets of these users (e.g., of the entire class or one or more subsets of the class). In some embodiments, the risk prediction can be provided to the algorithm monitoring API 424, can generate one or several graphical depictions based on second-level risk predictions, discussed below. One or both of the risk API 422 and the algorithm monitoring API 424 can then provide data to the interface engine 426. The interface engine 426 can comprise any hardware, software, or combination thereof that can generate a prediction, and specifically a risk prediction. The interface engine 426 can be located in or on the server 102, for example. In some embodiments, for example, the interface engine 426 can be located within a presentation system of the server 102 and can communication with the I/O subsystem (e.g., I/O subsystem 226) of one or several user devices 106 or supervisor devices to provide content to one or several users or supervisors.

With reference now to FIG. 4B, a schematic illustration of one embodiment of a process 430 for making a risk determination for a given student/user is shown. This process 430 is depicted in the form by some of the components of the content distribution network 100. The process 430 begins when one or several electrical signals communications corresponding to user inputs are sent from the user device 106 to the feature factory 406. In some embodiments, this indication can be direct from the user device 106 to the feature factory 406, and in some embodiments, this communication can pass through the input aggregator 402, the event data store 312, and/or the allocation engine 404. It should be understood that data for a single user may be collected by the feature factory 406 from multiple user devices 106 in some embodiments, and that the use of a single user device 106 in the present example is intended to be illustrative.

At the feature factory 406, a plurality of features (i.e., feature values for a plurality of features) 432 are generated by, for example, the normalization engine 410. In some embodiments, these features 432 can be generated based on the identification of one or several traits or attributes of the communications of electrical signals received from the user device 106 and the converting of those one or several traits or attributes of the communications electrical signals into one or several numbers, values, character strings, or the like. In the present example of FIG. 4B, these features include a first feature 432-A, a second feature 432-B, a third feature 432-C, and a fourth feature 432-D, each having respective feature values, although more or fewer features may be output by the feature factory 406 in other embodiments. These features can then be input into the prediction engine 416 which can use some or all the generated features 432 to generate a risk prediction for a given user (e.g., a user associated with the user device 106). In some embodiments, one or more of the features 432 can be input into the complex predictive model 418 of the prediction engine 416 to generate the risk prediction, and can be separately input into a logistic model of the logistic models 419 of the prediction engine 416. The logistic model may be associated with a given cluster, and coefficients of the logistic model may be used as a basis for generating a listing of one or more key features 438, which may define a subset of the features 432 that are estimated to have had the greatest comparative impact on the risk prediction generated by the complex predictive model 418. In some embodiments, the listing of one or more key features 438 may also include an estimated contribution (e.g., quantified as a contribution percentage or contribution score) of each of the features 432 to the risk prediction used as the basis for assigning the user to the at risk category 434 or the not at risk category 436. For example, if a given feature of the features 432 has a contribution score or contribution percentage exceeds a predetermined threshold, the given feature may be designated by the prediction engine 416 as a key feature in the listing of key features 438. As another example, if a ranking (e.g., a ranking based on contribution score or contribution percentage) of a given feature of the features 432 exceeds a predetermined ranking threshold (e.g., defining that the three features with the highest contribution scores or contribution percentages are key features), the given feature may be designated by the prediction engine 416 as a key feature in the listing of key features 438.

In some embodiments, after the risk prediction is generated, the user can be identified as belonging to one or several categories such as for example belonging to and at risk category 434 (e.g., in response to an “at risk” prediction being output by the prediction engine 416) or as belonging to a not at risk category 436 (e.g., in response to a “not at risk” prediction being output by the prediction engine 416). In some embodiments, additional categories can exist further dividing users according to risk levels. In some embodiments, the risk prediction and the users grouping in a risk category can be stored in the data store server 112, and specifically in the user data store 301.

Subsequent to assigning a user to one of the categories 434 and 436 based on the risk prediction, the server 102 and/or the servers 112, working in conjunction with the user data store 301, may cause an alert to be sent to a client device (e.g., via communication network(s) 120 of FIG. 1), such as one of the client devices 106, to alert the user or a supervisor (e.g., teacher) associated with the user that the user is “at risk” or is “not at risk”. This alert may also be accompanied by one or more recommendations (e.g., which may be generated by the server 102 and/or servers 112) suggesting that actions that may be taken to reduce the risk level of an “at risk” user. These recommendations may be generated based on the key features 438. For example, for a given user, if the key features 438 indicate that homework completion rate of the user is a feature having a large impact on that user's predicted risk level (i.e., the risk prediction for that user), the recommendations may suggest that the student finish homework assignments that they have not yet completed, if this option is available, and/or that the student be more diligent/thorough when completing future homework assignments. As another example, for a given user, if the key features 438 indicate that the user's guessing rate is a feature having a large impact on the user's predicted risk level (i.e., the risk prediction for that user), the recommendations may suggest that the student spend additional time when responding to each problem.

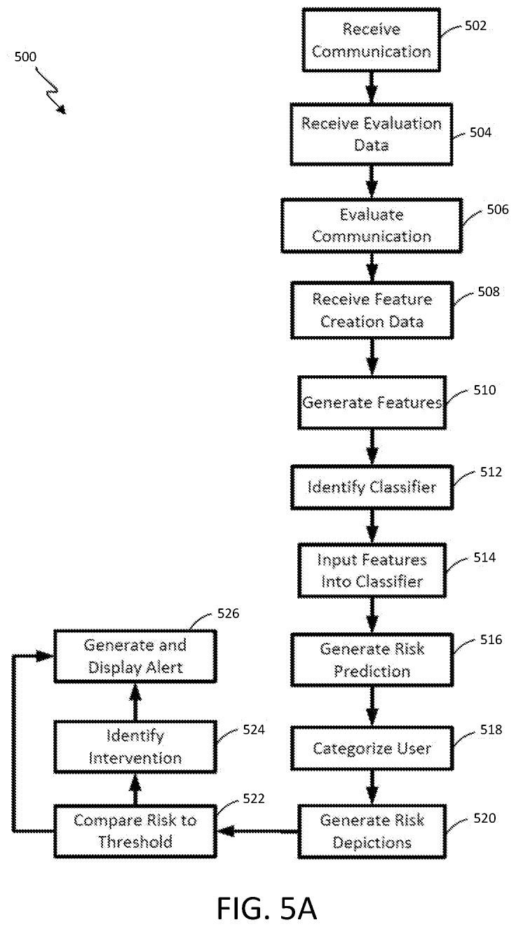

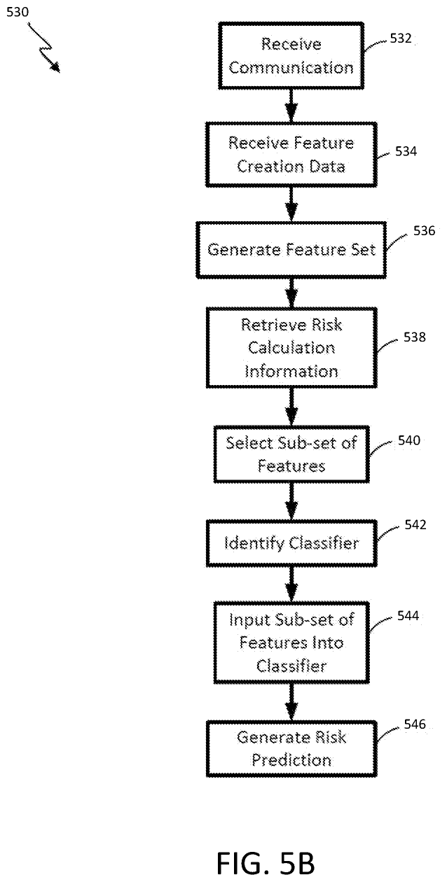

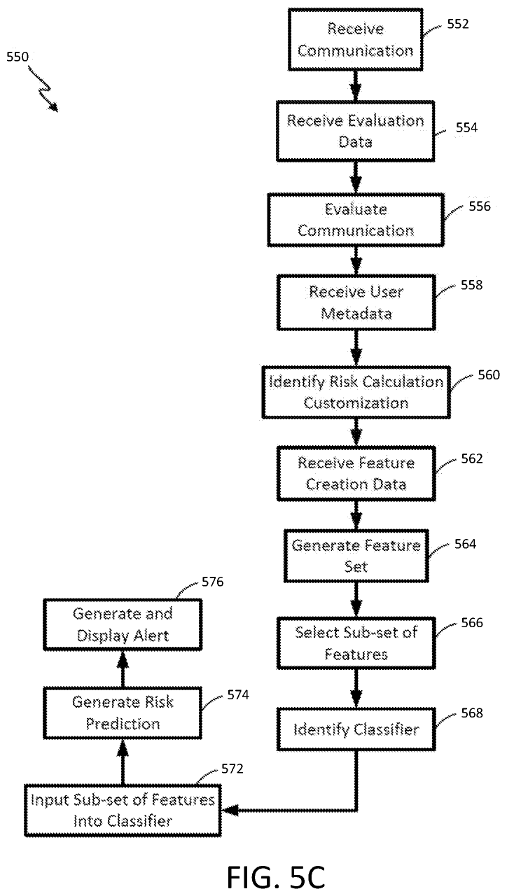

With reference now to FIG. 5A, a flowchart illustrating one embodiment of a method 500 for automatic alert triggering is shown. The method 500 can be performed by all or portions of the content distribution network 100 and specifically by one or more servers 102. The method 500 begins at block 502 wherein a communication is received by the server 102 from the user device 106 the communication network 120. This communication can comprise one or several electrical signals that can identify user interactions with all or portions of the content distribution network and/or content distributed by the content distribution network 100 to the user. This communication can comprise a payload that can be, for example, a response to one or several questions or one or several question parts. In some embodiments, this payload can further identify the content and/or question giving rise to the response.

After the communication is received, the method 500 proceeds to block 504 wherein evaluation data is received. In some embodiments, the server 102 can query the data store server 112 for evaluation information to evaluate the response received as a part of the communication in block 502. A memory device of the system (e.g., of storage system 210 or system memory 218 of FIG. 2) can identify this evaluation information within one of the databases, and specifically within the evaluation data store 308 and can provide this evaluation information to the server 102. After the evaluation data is received, the method 500 can proceed to block 506 wherein the communication, and specifically the response contained in the communication can be evaluated. This evaluation can be performed by the system 400 and/or by a processor of the server 102 and can include determining whether and/or the degree to which the user correctly responded to one or several questions or question parts.

After the communication has been evaluated, the method 500 proceeds to block 508 wherein feature creation data is received and/or retrieved. In some embodiments, the feature creation data can be received and/or retrieved from the data store server 112 and specifically from the event data store 312 in the data store server 112. In some embodiments, the server 102 can request feature creation data from the data store server 112, which request can include user metadata identifying one or several attributes of the user and/or metadata associated with the provided question are content to which the response to the communication was received. The data store server 112 can identify the relevant feature creation data and can provide the relevant feature creation data to the server 102. At block 510, the server 102, and specifically the feature engine 410 of the feature factory 406 can generate features according to the received feature creation data. In some embodiments, this can include the generation of one or several meaningful features based on the evaluation of the received communication, and/or in some embodiments, this can include the generation of one or several non-meaningful features. In some embodiments this can include the normalization performed by the normalization engine 408 before the generation of features by feature engine 410.

After the features have been generated, the method 500 proceeds to block 512 wherein a machine-learning algorithm is identified. In some embodiments, this can be the machine-learning algorithm which can be, for example, a model or classifier for use in generating the desired risk prediction. The machine-learning algorithm can include at least one of: a linear classifier; a Random Forrest algorithm; an Artificial Neural Network; an AdaBoost algorithm; a Naïve Bayes algorithm; Boosting Tree, and a Support Vector Machine. In some embodiments, for example, the configuration profile may identify a specific learning algorithm, model, and/or classifier in addition to specifying which features are to be used for generating the risk prediction. If such a learning algorithm, model, and/or classifier is identified, the server 102 can request this learning algorithm, model, and/or classifier from the data store server 112 and specifically from the model data store 309. The data store server 112 can retrieve the requested learning algorithm, model, and/or classifier and can provide data associated therewith and/or the learning algorithm, model, and/or classifier to the server 102.

At block 514 some or all of the generated features are inputted into the learning algorithm, model, and/or classifier. At block 516, a risk prediction is generated by the prediction engine 416 and specifically by the complex predictive model 418. In some embodiments, the prediction engine 416 can output a risk prediction or can output an indication that insufficient features have been provided to generate a risk prediction. After the risk prediction is generated, the method 500 proceeds to block 518 wherein the user's category is in one of several risk categories according to the risk level. In some embodiments, the categorization can be performed by the server 102 and specifically by the prediction engine 416. In some embodiments, this categorization can be performed by comparing the risk prediction to threshold values delineating between the several risk categories. Based on the result of the comparison between the risk prediction and the threshold values, the user can be identified as belonging to one of the risk categories and user metadata stored in the user profile data store 301 can be updated to reflect this categorization. In embodiments in which there are insufficient features to generate a risk prediction, the user can be identified as belonging to a category indicative of having no risk prediction and/or of lacking sufficient features to generate a risk prediction.

At block 520 one or several graphical depictions of risk are generated. In some embodiments, these graphical depictions of risk can take the risk level of the user from which the communication was received in block 502, the sources of risk, change in risk over time, or the like. These graphical depictions of risk can be generated by the risk API 422 which can be a part of, or operating on the server 102. After the graphical risk depictions have been generated, the method 500 proceeds to block 522 wherein the risk prediction is compared to an alert risk threshold. In some embodiments, the alert risk threshold can delineate between instances in which the risk prediction is sufficiently high so as to warrant an intervention or remediation from instances in which the risk prediction is not sufficiently high so as to warrant intervention or remediation. The risk alert threshold can be retrieved from the data store server 112, and specifically from the threshold data store 310.

If it is determined that an intervention is identified based on the comparison of the risk prediction and the alert risk threshold, then the method 500 proceeds to block 524 wherein an intervention is identified. In some embodiments, intervention can be identified based on user metadata and metadata associated with the question and/or content giving rise to the communication received from the user in block 502. This intervention can be retrieved from the data store server 112, and specifically from the content library data store 303 of the data store server 112.

After the intervention has been identified, or after determining that the risk prediction does not warrant an intervention, the method 500 proceeds to block 526 wherein an alert is generated and displayed and/or delivered. In some embodiments, the alert can comprise an indication of a risk level such as, for example, some of the one or several graphical depictions of risk generated in block 520. In some embodiments, the alert can comprise a user interface containing these graphical depictions of risk for the user or for a group to which the user belongs. In some embodiments, the alert can comprise an electronic communication sent from the server 102 to the user device 106 and/or a supervisor device. This electronic communication can include code to direct the launch of the user interface and a display of the graphical risk depictions generated in block 520. In some embodiments, the alert can further be configured to deliver an indication of the intervention identified in block 524.

With reference now to FIG. 5B, a flowchart illustrating one embodiment of a method 530 for triggering a pre-emptive alert is shown. The method 530 can be performed by all or portions of the content distribution network. The method 530 begins at block 532 where a communication is received by the server 102 from the user device 106 or the communication network 120. This communication can comprise one or several electrical signals that can identify user interactions with all or portions of the content distribution network and/or content distributed by the content distribution network 100 to the user. This communication can comprise a payload that can be, for example, a response to one or several questions or one or several question parts. In some embodiments, this payload can further identify the content and/or question giving rise to the response.

After the communication is received, the method 530 proceeds to block 534 wherein feature creation data is received and/or retrieved. In some embodiments, the feature creation data can be received and/or retrieved from the data store server 112 and specifically from the event data store 312 in the data store server 112. In some embodiments, the server 102 can request feature creation data from the data store server 112, which request can include user metadata identifying one or several attributes of the user and/or metadata associated with the provided question are content to which the response to the communication was received. The data store server 112 can identify the relevant feature creation data and can provide the relevant feature creation data to the server 102. At block 536, the server 102, and specifically the feature engine 410 of the feature factory 406 can generate features according to the received feature creation data. In some embodiments, some or all of the generated features can be meaningful, and/or in some embodiments some or all of the features can be non-meaningful. In some embodiments this can include the normalization performed by the normalization engine 408 before the generation of features by feature engine 410.

In block 538 risk calculation information is retrieved. In some embodiments, the risk calculation information can comprise portions of the configuration profile identifying a subset of features for use in generating the risk prediction. The configuration profile and thus the risk calculation information can be identified based on one or several traits or attributes of the user as identified in the user metadata. After the risk calculation information has been retrieved, the method 530 proceeds block 540 wherein a sub-set of features is selected. In some embodiments, for example, the feature set generated in block 536 includes more features than identified in the risk calculation information for use in calculating the user's risk prediction. In such an embodiment, the sub-set of features is selected from the feature set generated in block 536, which sub-set of features coincides with the features identified in the configuration profile.

After the sub-set of features is selected, the method 530 proceeds to block 542 wherein a machine-learning algorithm is identified. In some embodiments, this can be the machine-learning algorithm which can be, for example, a model or classifier, such as a linear classifier or a probabilistic classifier, for use in generating the desired risk prediction. In some embodiments, the machine-learning algorithm, model, or classifier can comprise one of: Random Forrest algorithm; an Artificial Neural Network; an AdaBoost algorithm; a Naïve Bayes algorithm; Boosting Tree, and a Support Vector Machine. In some embodiments, for example, the configuration profile may identify a specific learning algorithm, model, and/or classifier in addition to specifying which features to be used for generating the risk prediction. If such a learning algorithm, model, and/or classifier is identified, the server 102 can request this learning algorithm, model, and/or classifier from the data store server 112 and specifically from the model data store 309. The data store server 112 can retrieve the requested learning algorithm, model, and/or classifier and can provide data associated therewith and/or the learning algorithm, model, and/or classifier to the server 102.

After the machine-learning algorithm has been identified, the method 530 proceeds to block 544 wherein the sub-set of features is input into the machine-learning algorithm. In some embodiments, this can include the formatting or modification of the features so as to correspond with requirements of the machine-learning algorithm. After the sub-set of features has been inputted into the machine-learning algorithm, the method 530 proceeds to block 546 wherein the risk prediction is generated by the machine-learning algorithm selected in block 542. In some embodiments, after the generation of the risk prediction, the process 830 can proceed to blocks 522 through 526 of FIG. 5A.

With reference now to FIG. 5C, a flowchart illustrating one embodiment of a method 550 for on-the-fly alert triggering customization is shown. The method 550 can be performed by all or portions of the content distribution network 100. The method 550 begins at block 552 wherein a communication is received by the server 102 from the user device 106 on the communication network 120. This communication can comprise one or several electrical signals that can identify user interactions with all or portions of the content distribution network and/or content distributed by the content distribution network 100 to the user. This communication can comprise a payload that can be, for example, a response to one or several questions or one or several question parts. In some embodiments, this payload can further identify the content and/or question giving rise to the response. In some embodiments, communications can be received from multiple devices, and specifically from a first user device and a second user device.

After the communication is received, the method 550 proceeds to block 554 wherein evaluation data is received. In some embodiments, the server 102 can query the data store server 112 for evaluation information to evaluate the response received as a part of the communication in block 502. A memory device of the system (e.g., of storage system 210 or system memory 218 of FIG. 2) can identify this evaluation information within one of the databases, and specifically within the evaluation data store 308 and can provide this evaluation information to the server 102. After the evaluation data is received, the method 550 can proceed to block 556 wherein the communication, and specifically the response contained in the communication can be evaluated. In embodiments in which communications are received from multiple devices, communications from each of the multiple devices can be evaluated, thus the communication from the first user device 106 can be evaluated and the communication from the second user device 106 can be evaluated. This evaluation can be performed by the system 400 and/or by the processor of the server 102 and can include determining whether and/or the degree to which the user correctly responded to one or several questions or question parts.

After the evaluation of the communication, the method 550 proceeds to block 558 wherein user metadata is received. In some embodiments, the user metadata can be received by the server 102 from the data store server 112, and specifically from the user profile data store 301 of the data store server 112. In some embodiments, all or portions of the user metadata are unique to the user of the user device 106 and in some embodiments, all or portions of the user metadata are non-unique to the user of the user device 106. In embodiments in which the metadata are unique, the metadata can be generated based on the individual user's interactions with the content of the content distribution network 100, and in embodiments in which the metadata are non-unique, the metadata can be generated based on the individual user's belonging to a group or cohort such as, for example, a class, a school, a program, or the like. In some embodiments, non-unique user metadata can be shared by a group or cohort of users sharing at least one common attribute. In embodiments in which communications are received from multiple user devices, user metadata can be received for the user of each of the user devices 106 from which a communication is received.

After the user metadata is received, the method 550 proceeds to block 560 wherein a risk calculation customization is identified. In some embodiments, the risk calculation customization can correspond to features used for a risk prediction and/or the machine-learning algorithm used for the risk prediction. The risk calculation customization can be identified in the configuration profile which can identify a sub-set of features for use in generating the risk prediction and/or the machine-learning algorithm, model, and/or classifier for use in generating this risk prediction. In embodiments in which communications are received from multiple user devices, a configuration profile for each of the user devices 106 can identified. The configuration profile and thus the risk customization can be identified based on one or several traits or attributes of the user as identified in the user metadata.

After the risk calculation customization is generated, the method 550 proceeds to block 562, wherein feature creation data is received and/or retrieved. In some embodiments, the feature creation data can be received and/or retrieved from the data store server 112 and specifically from the event data store 312 in the data store server 112. In some embodiments, the server 102 can request feature creation data from the data store server 112, which request can include user metadata identifying one or several attributes of the user and/or metadata associated with the provided question are content to which the response to the communication was received. The data store server 112 can identify the relevant feature creation data and can provide the relevant feature creation data to the server 102. At block 564, the server 102, and specifically the feature engine 410 of the feature factory 406 can generate features, and specifically a set of features according to the received feature creation data. In some embodiments this can include the normalization performed by the normalization engine 408 before the generation of features by feature engine 410. In some embodiments, the set of features generated in step 562 coincides with the features identified in the risk calculation customization, and in some embodiments, features in addition to those identified in the risk calculation customization are generated. In embodiments in which communications are received from multiple user devices 106, a set of features can be generated for communications from each of the multiple user devices 106.

After the feature set is generated, the method 550 proceeds to block 566 wherein a sub-set of features is identified and selected. In some embodiments, the sub-set of features is selected from the feature set generated in block 564, which sub-set of features coincides with the features identified in the configuration profile. In embodiments in which communications are received from multiple user devices 106, a sub-set of features can be identified from the set of features created for each of the user devices 106.

After the sub-set of features is selected, the method 550 proceeds to block 568 wherein a machine-learning algorithm is identified. In some embodiments, this can be the machine-learning algorithm which can be, for example, a model or classifier for use in generating the desired risk prediction. In some embodiments, for example, the configuration profile may identify a specific one of several learning algorithms, models, and/or classifiers in addition to specifying which features are to be used for generating the risk prediction. In some embodiments, the configuration profile can be based on portions of the user metadata that are unique to the user and/or on portions of the user metadata that are non-unique to the user. If such a learning algorithm, model, and/or classifier is identified, the server 102 can request this learning algorithm, model, and/or classifier from the data store server 112 and specifically from the model data store 309. In embodiments in which communications are received from multiple user devices 106, a learning algorithm can be identified for the risk prediction for each of the user devices 106, which learning algorithm can be identified based on the configuration profile of each of the user devices 106. The data store server 112 can retrieve the requested learning algorithm, model, and/or classifier and can provide data associated therewith and/or the learning algorithm, model, and/or classifier to the server 102.

After the learning algorithm has been identified, the method 550 proceeds to block 572, wherein the sub-set of features is input into the machine-learning algorithm. In some embodiments, this can include the formatting or modification of the features so as to correspond with requirements of the machine-learning algorithm. In embodiments in which communications are received from multiple user devices 106, a sub-set of features selected for each of the user devices 106 from which a communication was received can be inputted into the machine-learning algorithm identified for the user associated with that user device 106 in block 568. In some embodiments, inputting the sub-set of features into the classifier can comprise: generating a feature vector for each of the features in the sub-set of features; and inputting the feature vectors into the classifier. After the sub-set of features has been inputted into the machine-learning algorithm, the method 550 proceeds to block 574 wherein the risk prediction is generated by the machine-learning algorithm selected in block 568. In embodiments in which communications are received from multiple user devices 106, this can include the generation of multiple risk predictions.

After the risk prediction is generated, the method 550 proceeds to block 576, wherein an alert is generated and displayed and/or delivered. In some embodiments, the alert can comprise an indication of a risk level such as, for example, some of the one or several graphical depictions of risk. In some embodiments, the alert can comprise a user interface containing these graphical depictions of risk for the user or for a group to which the user belongs. In embodiments in which communications are received from multiple user devices 106, this can include the generating and sending of an alert to some or all of the user devices 106 from which a communication was received in block 552. In some embodiments, the alert can comprise an electronic communication sent from the server 102 to the user device 106 and/or a supervisor device. This electronic communication can include code to direct the launch of the user interface and a display of the graphical risk depictions. In some embodiments, the alert can further be configured to deliver an indication of the intervention identified in block 524.

The methods of FIGS. 5A-5C are useful for determining whether a particular user is ‘at risk’ or not ‘at risk’, but it may be beneficial to generate and provide additional insights (e.g., to an instructor) that identify why an ‘at risk’ user is considered to be at risk. For example, returning to FIGS. 4A and 4B, when features 412, 432 corresponding to a given user are provided to the prediction engine 416 and the user is assigned to the at risk category 434 based on the prediction output by the prediction engine 416, there may not be transparency as to the individual contributions made by each feature of the features 412, 432 to the risk prediction generated by the prediction engine 416 if the prediction engine 416 included only a single complex predictive model 418. However, the inclusion of additional models such as the logistic models 419 in the prediction engine 416, allows the prediction engine 416 to produce a listing of one or more key features 438, which may define the contribution of each feature input to the prediction engine 416 to risk predictions generated for a given user, as will be described.

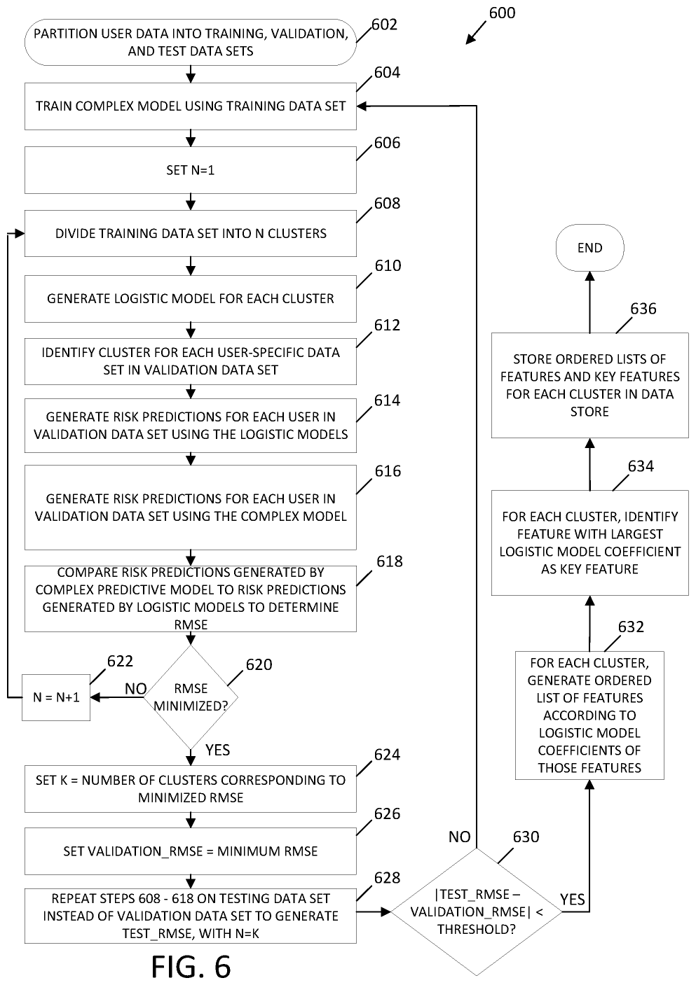

By clustering (e.g., partitioning based on similarity) users and then building logistic models (e.g., logistic models 419) on top of the resultant clusters, a given student can be classified as “at risk” or “not at risk” via risk predictions generated by both a corresponding logistic model of the logistic models 419 and the (generally) comparatively more complex predictive model 418. While the complex predictive model 418 (e.g., if a neural network model or a random forest model) may not provide transparency as to which input features contribute to the risk prediction for a student output by the complex predictive model 418 in some embodiments, it is possible to analyze coefficients of the logistic models 419 to determine how much individual input features of the features 432 impact a given logistic model's risk prediction. Individual features' contributions to the risk prediction generated by a given one of the logistic models 419 (e.g., based on corresponding coefficients of the logistic model) may be considered to have a similarly significant (or insignificant) contribution to the risk prediction generated by the complex predictive model 418. FIG. 6 provides an illustrative example of a method by which users may be organized into clusters, by which logistic models such as logistic models 419 may be built on those clusters, by which the logistic models may be verified against a more complex model such as the complex predictive model 418, by which a prediction engine such as prediction engine 416 may, for each cluster, identify the contribution of each input feature to risk predictions generated for users in that cluster, and by which key features may be identified based on the identified contributions. FIG. 6 illustrates a process flow for a method 600 by which logistic models may be built on defined clusters of training data, verified against a corresponding complex predictive model (e.g., a neural network or random forest model; complex predictive model 418 of FIG. 4A), and then used to identify key features of each cluster. The method 600 may be performed by executing computer-readable instructions with one or more processors (referred to below as “the processor” for sake of simplicity) of one or more computer systems (e.g., processors of clients 106, servers 102, servers 112, FIG. 1; processing units 204 of the computer system 200, FIG. 2; processing units that implement feature factory 406, 416, or training engine 420 of FIG. 4A). The instructions may be stored on a computer-readable medium (e.g., computer memory, storage device, etc.) of the one or more computer systems or communicatively coupled to the one or more computer systems. For example, some or all steps of the method 600 may be performed by the system 400 of FIG. 4A and/or in connection with the process 430 of FIGS. 4B.

At block 602, the processor (e.g., via the training engine 420 of FIG. 4A) partitions a set of user data into a training data set, a validation data set, and a test data set (e.g., at a ratio of 60:20:20). The set of user data may be retrieved from an event data store (e.g., event data store 312, FIGS. 3, 4A) and may include, as subsets, user-specific data sets for each of a number of different users. For each user-specific data set, a user-specific feature set may be derived (e.g., by the feature factory 406 of FIG. 4). For example, a given user-specific feature set may include features derived from interactions between a corresponding user and assessments/activities delivered to that user, as reflected in the user-specific data set for that user. For example, the features may include, but are not limited to: a homework load (e.g., which may be quantified as the user's average homework score over a recent defined period of time, such as the past three weeks); a guessing rate (e.g., quantified via a Hurst coefficient calculated for the student); average correct on first try percent; an average score which can include an average homework score and/or an average test score; an average part score; a number of attempted parts; an average number of attempted parts; an average number of attempts per part; and an aggregation parameter such as, for example, one or several course level aggregations. In some embodiments, these features can be calculated with data collected within a window, which window can be a temporally bounded window, or a window bounded by a number of received response. In such an embodiment, for example, the window can be a sliding window, also referred to herein as a sliding temporal window that can include information relating to some or all of one or several users' interaction with the content distribution network during a designated time period such as, for example, a 1 week time period, a ten day time period, a two week time period, a three week time period, a four week time period, a six week time period, a twelve week time period, or any other or intermediate period of time.

At block 604, the processor may train a complex predictive model (e.g., a neural network or random forest model; complex predictive model 418 of FIG. 4A) to generate a risk prediction for a user based on the features of that the user-specific feature set associated with that user (e.g., using training engine 420 of FIG. 4A). For example, the processor may set initial parameters for the complex predictive model, and may apply the complex predictive model to each user-specific feature set derived from the training data set. Each time the complex predictive model is applied to a given user-specific feature set derived from the training data set, the parameters of the complex predictive model may be adjusted, such that a predefined loss function is minimized through repeated application of the complex predictive model to the user-specific feature sets derived from the training data set (e.g., via the feature factory 406 of FIG. 4). Adjustment of the parameters of the complex predictive model may be performed based on how well the complex predictive model predicted risk for the user associated with a particular user-specific feature set derived from that user's user-specific data set (e.g., retrieved from the event data store 312). For example, the processor may compare the risk prediction output by the complex predictive model to actual observed outcomes for the user, and the adjustments to the complex predictive model parameters may be made based on this comparison. The particular loss function to be minimized via this training may depend on the type of model being trained.

At block 606, the processor sets a variable N (e.g., stored in a memory coupled to the processor) equal to 1. As will be described, the variable N defines the number of clusters into which the training data set is to be divided.

At block 608, the processor divides the training data set into “N” clusters, based on the variable N defined in block 606 or block 622. For example, the training data set may be divided into clusters using a k-means clustering approach. It should be understood that, in other embodiments, alternative clustering techniques can be used, which may include hierarchical clustering, k-harmonic means clustering, and/or fuzzy k-means clustering.

At block 610, the processor generates a logistic model for each cluster. For example, for a given cluster, a logistic model may be trained to generate a risk prediction based on input features that may be the same as the input features required by the complex model. The logistic model may include a number of variables and corresponding coefficients (sometimes referred to as variable-coefficient pairs), where each variable represents a respective input feature and each coefficient represents a magnitude of the impact of the respective input feature on predictions output by the logistic model. For example, the value of the logistic model coefficient corresponding to the homework load feature would define the magnitude of the impact of the homework load value on the the prediction output by the logistic model for a given student belonging to the cluster on which the logistic model was built/trained.

At block 612, for each user-specific feature set derived from user data in the validation data set (e.g., derived via the feature factory 406 of FIG. 4), the processor identifies the cluster to which that user-specific feature set is associated. For example, the processor may determine which cluster center of the clusters is closest to the user-specific feature set (e.g., based on the Euclidean distance between the user-specific feature set and the cluster centers). For example, the cluster center, defined through the process of k-means clustering, may be defined as a feature vector, where each the value of each feature of the feature vector is calculated as an average of the values of corresponding features of user-specific feature sets included in the cluster associated with the cluster center. The processor may then assign the user-specific feature set (and the corresponding user) to the cluster associated with that cluster center.

At block 614, the processor generates risk predictions for each user represented in the validation data set using the logistic models based on the user-specific feature sets of those users. For example, when N=2, a first logistic model corresponding to a first cluster may generate risk predictions only for users having user-specific feature sets derived from the validation data set included in the first cluster, while a second logistic model corresponding to a second cluster may generate risk predictions only for users having user-specific feature sets derived from the validation data set included in the second cluster.

At block 616, the processor determines risk predictions for each user represented in the validation set, based on the user-specific feature sets of those users.

At block 618, the processor compares the risk predictions generated by the complex predictive model to the risk predictions generated by the logistic models. Based on this comparison, the processor determines a root mean square error (RMSE) value between the complex predictive model risk predictions and the logistic model risk predictions.

At block 620, the processor determines if the RMSE has been minimized based on all RMSE values that have been generated during the present instance of the method 600. Generally, as the value of N increases, starting from N=1, the corresponding RMSE values will increase until a minimum RMSE value is reached, after which the RMSE value will begin increasing as the value of N increases. In an illustrative example, through four consecutive iterations of blocks 608-622, the processor may determine that an RMSE value for N=1 is greater than an RMSE value for N=2, which is greater than an RMSE value for N=3, which is greater than an RMSE value for N=4. On the fifth iteration, the processor may determine that an RMSE value for N=5 is greater than the RMSE value for N=4. The processor would then determine that the RMSE value for N=4 is the minimum RMSE value.

If the processor is able to identify a minimum RMSE value based on the available RMSE values that have been calculated by the processor, the method proceeds to block 624. Otherwise, the method proceeds to block 622.

At block 622, the processor sets N=N+1 to increment the value of N (and therefore the number of clusters to be generated during the next iteration of block 608) by 1. The method then returns to block 608, forming an iterative loop.

At block 624, the processor sets a variable K equal to the number of clusters corresponding to the minimized RMSE. Continuing the illustrative example in which the processor has determined that the minimum RMSE value for N=4 is the minimum RMSE value, K would be set equal to 4.

At block 626, the processor sets a variable VALIDATION_RMSE equal to the minimum RMSE value identified at block 620. In some embodiments, the order of blocks 624 and 626 may be reversed or performed in parallel.

At block 628, the processor repeats blocks 608-618, substituting the testing data set in place of the validation data set, and setting N=K, to determine an RMSE value for the testing data. The processor sets a variable TEST_RMSE equal to the RMSE value for the testing data. In some embodiments, the results of dividing the training data set into K clusters and the logistic models derived from those clusters may be stored in a memory device coupled to the processor, and may be retrieved by the processor during block 628 such that repetition of blocks 608 and 610 in block 628 may not be required.

At block 630, the processor compares a magnitude of a difference between TEST_RMSE and VALIDATION_RMSE to a predetermined threshold. If the magnitude exceeds the predetermined threshold, this indicates that the logistic models built on the K clusters do not have an acceptable level of generalizability, and the method 600 returns to step 604 (e.g., to attempt to create more generalized logistic models). If the magnitude does not exceed the threshold, this indicates that the logistic models built on the K clusters have an acceptable level of generalizability, and the method 600 proceeds to block 632.

At block 632, the processor generates an ordered list of input features (e.g., features 412, 432, FIGS. 4A, 4B) for each of the clusters. To generate the ordered list for a given cluster, the processor may analyze the logistic model for N=K corresponding to that cluster to identify which coefficients of the logistic model correspond to each input feature. The processor may rank the features of the ordered list according to their corresponding logistic model coefficients.

At block 634, the processor identifies, for each cluster, the feature of the ordered list associated with that cluster having the highest rank (e.g., being associated with the largest logistic model coefficient). For a given cluster, the processor may designate the feature identified as having the highest rank as being the “key feature” for that cluster. For example, if the key feature for a given cluster is “average homework score,” this indicates that the factor (e.g., out of the factors represented as features in the user-specific feature sets) that contributes most significantly to risk predictions for users of that cluster is an individual user's homework score. In some embodiments, a predefined number of the highest ranking features may be designated as the key features for the cluster, rather than only designating a single key feature. In some embodiments, all features associated with logistic model coefficients exceeding a predetermined threshold may be designated as the key features for the cluster, rather than one or more key features being designated based on ranking.

At block 636, the processor causes the ordered lists and key features for each cluster to be stored in a data store (e.g., a key feature data store and/or the user data store 301 of FIG. 4A) of one or more data store servers (e.g., data store servers 112, 300, FIGS. 1, 3). As will be described, these key features may be subsequently used as a basis for determining how an instructor or other actor may intervene with a user who has been predicted by the complex predictive model as being at-risk. In some embodiments, metadata may be stored along with each key feature, which associates that key feature with its corresponding cluster and vice versa.

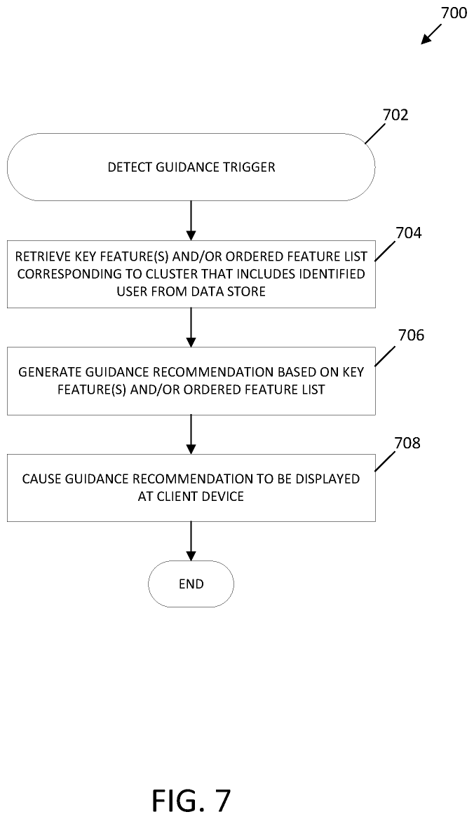

FIG. 7 illustrates a process flow for a method 700 by which one or more key features (e.g., having been previously identified via the method 600 of FIG. 6). The method 700 may be performed by executing computer-readable instructions with one or more processors (referred to below as “the processor” for sake of simplicity) of one or more computer systems (e.g., processors of clients 106, servers 102, servers 112, FIG. 1; processing units 204 of the computer system 200, FIG. 2). The instructions may be stored on a computer-readable medium (e.g., computer memory, storage device, etc.) of the one or more computer systems or communicatively coupled to the one or more computer systems. For example, some or all steps of the method 700 may be performed by the system 400 of FIG. 4A.

At block 702, the processor detects a guidance trigger. For example, the guidance trigger may be a request from a client device (e.g., a client device of an instructor; the client device 106 of FIG. 1) for the processor to provide guidance for an at-risk user (e.g., the user determined to be at risk based on a risk prediction generated by the complex predictive model 418 of the prediction engine 416 of FIG. 4A). Alternatively, the guidance trigger may be automatically generated (e.g., by the processor or by the client device; as a flag in a memory device coupled to the processor or as a signal sent to the processor by the client device) in response to detecting that a risk prediction (e.g., generated by the complex predictive model 418 of FIG. 4A) for a user exceeds a predetermined threshold or otherwise indicates that the user is “at risk”.

At block 704, the processor identifies a cluster associated with the user (e.g., by identifying the cluster having a cluster center most closely related to the user-specific data set corresponding to the user) and retrieves one or more key features and/or an ordered feature list associated with the identified cluster from a data store (e.g., a key feature data store or the event data store 312 of the data store servers 112, 300, FIGS. 1, 3). For example, the processor may identify the association between the cluster and the one or more key features based on metadata defining such association, which may be stored in the data store.

At block 706, the processor generates a guidance recommendation based on the one or more key features and/or the ordered feature list. The guidance recommendation may differ depending on the key feature(s) associated with the identified cluster. For example, if a key feature associated with the identified cluster is the average homework score of the user, the guidance recommendation may suggest that the user be assigned more homework. If a key feature associated with the identified cluster is the average number of attempts per part, the guidance recommendation may recommend that the user be allowed to make more or fewer attempts on each item part delivered to the user as part of homework assignments or other assessments. As another example, if the key feature associated with the identified cluster is the guessing rate/Hurst coefficient, the recommendation may suggest that the student spend additional time when responding to each question. In some embodiments, the guidance recommendation may include the ordered list itself.

At block 708, the processor causes the guidance recommendation to be displayed at and/or stored on a memory device of a client device. For example, the processor may send the guidance recommendation to the client device via an electronic communication network (e.g., via communication network(s) 120 of FIG. 1). For example, the client device may be the client device that generated the guidance trigger and/or may be a client device associated with an instructor of the user (e.g., which may be defined in a user profile of the user, which may be stored in the user data store 301 of FIGS. 3, 4A) and/or a client device associated with the user himself/herself.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method comprising:
retrieving user data for a plurality of users from an event data store;
training a complex predictive model based on a portion of the user data to generate user risk predictions based on inputs that include a set of features;
generating, from the portion of the user data, user-specific feature sets including feature values for each feature of the set of features;
identifying a key feature by:
dividing the user-specific feature sets into a plurality of clusters based on the feature values;
generating, for a cluster of the plurality of clusters, a representative logistic model having a plurality of coefficients, each of the plurality of coefficients being associated with a respective feature of the set of features;
identifying, for the cluster, the key feature of the set of features based on the plurality of coefficients of the representative logistic model; and
storing, in the event data store, the key feature and metadata that associates the key feature with the cluster;
processing a user-specific feature set of a user with the complex predictive model to generate a risk prediction;
in response to generating the risk prediction, determining that the user-specific feature set of the user corresponds to a cluster center of the cluster;
determining, based on the metadata, that the key feature is associated with the cluster;
generating a guidance recommendation based on the key feature; and
causing the guidance recommendation to be displayed at a remote device associated with an instructor of the user.

2. The method of claim 1, wherein the plurality of clusters is a first plurality of clusters that includes a first quantity of clusters, wherein identifying the key feature comprises:
generating, for each of the first plurality of clusters, a first plurality of logistic models that includes the representative logistic model;
dividing the user-specific feature sets into a second plurality of clusters that includes a second quantity of clusters;
generating, for each of the second plurality of clusters, a second plurality of logistic models;
dividing the user-specific feature sets into a third plurality of clusters that includes a third quantity of clusters;
generating, for each of the third plurality of clusters, a third plurality of logistic models;
generating, from a second portion of the user data, second user-specific feature sets;
generating first risk predictions with the first plurality of logistic models based on the second user-specific feature sets;
generating second risk predictions with the second plurality of logistic models based on the second user-specific feature sets; and
generating third risk predictions with the third plurality of logistic models based on the second user-specific feature sets.

3. The method of claim 2, wherein the first quantity is greater than the second quantity, and wherein the third quantity is greater than the first quantity.

4. The method of claim 3, further comprising:
generating fourth risk predictions with the complex predictive model based on the second user-specific feature sets; and
comparing the fourth risk predictions to the first, second, and third risk predictions to determine respective first, second, and third error values.

5. The method of claim 4, further comprising:
determining that the first plurality of clusters is associated with minimized error by determining that the first error value is less than the second error value and less than the third error value.

6. The method of claim 5, wherein the first, second, and third error values comprise respective first, second, and third root mean square error values.

7. The method of claim 5, further comprising:
generating, from a third portion of the user data, third user-specific feature sets;
generating fifth risk predictions with the first plurality of logistic models based on the third user-specific feature sets;
generating sixth risk predictions with the complex predictive models based on the third user-specific feature sets;
determining a fourth error value by comparing the fifth risk predictions to the sixth risk predictions; and
validating the first plurality of logistic models by determining that a difference between the first error value and the fourth error value is less than a predetermined threshold.

8. A method comprising:
training, based on a training data set, a complex predictive model to generate risk predictions based on a set of features that characterize student activity;
generating, from the training data set, user-specific feature sets, each defining respective feature values for the set of features;
dividing the user-specific feature sets into a plurality of clusters;
generating a representative logistic model for a cluster of the plurality of clusters, the representative logistic model having a plurality of coefficients, each of the plurality of coefficients being associated with a respective feature of the set of features;
identifying, for the cluster, a key feature of the set of features based on the plurality of coefficients;
processing a user-specific feature set corresponding to a student with the complex predictive model to generate a risk prediction;
determining that the user-specific feature set corresponds to a cluster center of the cluster;
determining that the key feature is associated with the cluster;
generating a guidance recommendation based on the key feature; and
causing the guidance recommendation to be displayed at a remote device.

9. The method of claim 8, wherein the plurality of clusters includes a first quantity of clusters, wherein identifying the key feature comprises:
generating a first plurality of logistic models that includes the representative logistic model, wherein each of the first plurality of logistic models is generated based on a respectively different cluster of the first quantity of clusters;
dividing the user-specific feature sets into a second quantity of clusters;
generating a second plurality of logistic models, wherein each of the second plurality of logistic models is generated based on a respectively different cluster of the second quantity of clusters;
dividing the user-specific feature sets into a third quantity of clusters;
generating a third plurality of logistic models, wherein each of the third plurality of logistic models is generated based on a respectively different cluster of the third quantity of clusters;
generating, from a validation data set, second user-specific feature sets;
generating first risk predictions with the first plurality of logistic models based on the second user-specific feature sets;
generating second risk predictions with the second plurality of logistic models based on the second user-specific feature sets; and
generating third risk predictions with the third plurality of logistic models based on the second user-specific feature sets.

10. The method of claim 9, wherein the first quantity is greater than the second quantity, and wherein the third quantity is greater than the first quantity.

11. The method of claim 10, further comprising:
generating fourth risk predictions with the complex predictive model based on the second user-specific feature sets; and
comparing the fourth risk predictions to the first, second, and third risk predictions to determine respective first, second, and third error values.

12. The method of claim 11, further comprising:
determining that the first quantity of clusters is associated with minimized error by determining that the first error value is less than the second error value and less than the third error value.

13. The method of claim 12, wherein the first, second, and third error values comprise respective first, second, and third root mean square error values.

14. The method of claim 12, further comprising:
generating, from a testing data set, third user-specific feature sets;
generating fifth risk predictions with the first plurality of logistic models based on the third user-specific feature sets;
generating sixth risk predictions with the complex predictive models based on the third user-specific feature sets;
determining a fourth error value by comparing the fifth risk predictions to the sixth risk predictions; and
validating the first plurality of logistic models by determining that a difference between the first error value and the fourth error value is less than a predetermined threshold.

15. A system comprising:
an event data store that stores user data for a plurality of users; and
a server comprising:
a processor; and
a memory device configured to store computer-readable instructions, which when executed cause the processor to:
implement a feature engine configured to:
retrieve a portion of the user data from the event data store; and
generate, from the portion of the user data, user-specific feature sets including feature values for a set of features;
implement a training engine configured to:
train a complex predictive model based on the user-specific feature sets, the complex predictive model being trained to generate risk predictions based on to the set of features;
divide the user-specific feature sets into a plurality of clusters; and
identify a key feature by:
dividing the user-specific feature sets into a plurality of clusters;
generating, for a given cluster of the plurality of clusters, a representative logistic model having a plurality of coefficients, each of the plurality of coefficients being associated with a respective feature of the set of features;
identifying, for the given cluster, the key feature of the set of features based on the plurality of coefficients of the representative logistic model; and
storing, in the event data store, the key feature and metadata that associates the key feature with the given cluster;
implement a prediction engine that includes the complex predictive model, and that is configured to:
process a user-specific feature set corresponding to a user with the complex predictive model to generate a risk prediction; and
determine that the user is at risk based on the risk prediction; and
in response to determining that the user is at risk with the prediction engine, cause a guidance recommendation to be displayed at a remote device.

16. The system of claim 15, wherein, to cause the guidance recommendation to be displayed at the remote device, the computer-readable instructions, when executed, cause the processor to:
in response to determining that the user is at risk with the prediction engine, determine that the user-specific feature set corresponding to the user corresponds to a cluster center of the given cluster;
determine, based on the metadata, that the key feature is associated with the given cluster;
generate a guidance recommendation based on the key feature; and
send the guidance recommendation to be displayed at the remote device via an electronic communication network, wherein the remote device is associated with an instructor of the user.

17. The system of claim 16, wherein the computer-readable instructions, when executed, cause the processor to:
generate first, second, and third quantities of clusters, the plurality of clusters corresponding to the first quantity of clusters;
generate, first, second, and third pluralities of logistic models to represent, respectively, the first, second, and third quantities of clusters;
generate, from a second portion of the user data, second user-specific feature sets;
generate, with the first, second, and third pluralities of logistic models, first, second, and third sets of predictions based on the second user-specific feature sets; and
determine that the first quantity of clusters and the first plurality of logistic models correspond to minimized prediction error.

18. The system of claim 17, wherein, to determine that the first quantity of clusters and the first plurality of logistic models correspond to minimized prediction error, the computer-readable instructions, when executed, cause the processor to:
generate, with the complex predictive model, a fourth set of predictions based on the second user-specific data sets;
determine first, second, and third error values between respective first, second, and third sets of predictions generated by the first, second, and third pluralities of logistic models and a fourth set of predictions generated by the complex predictive model; and
determine that the first error value is less than the second error value and the third error value, wherein the first quantity is less than the second quantity and greater than the third quantity.

19. The system of claim 18, wherein the computer-readable instructions, when executed, cause the processor to:
generate, based on a third portion of the user data, third user-specific feature sets; and
upon determining that the first quantity of clusters and the first plurality of logistic models correspond to minimized prediction error:
generate a fifth set of predictions with the first plurality of logistic models;
generate a sixth set of predictions with the complex predictive model;
compare the fifth set of predictions to the sixth set of predictions to determine a fourth error value; and
validate the first plurality of logistic models by determining that a difference between the first error value and the fourth error value is less than a predetermined threshold.

20. The system of claim 19, wherein the first, second, third, and fourth error values are root mean square error values.
